(19) United States
(12) Patent Application Publication
(10) Pub. No.: US 2026/0127639 A1
(43) Pub. Date: May 7, 2026

(54) CONDITIONAL CONTENT SELECTION PROCEDURES

(71) Applicant: GOOGLE LLC, Mountain View, CA (US)

(72) Inventors: Anita Lu, Mountain View, CA (US); Zhiwen Guan, Mountain View, CA (US); Vinay Vemuri, Mountain View, CA (US); Shweta Agrawal, Mountain View, CA (US); Joseph Joseph Cherukara, Mountain View, CA (US); Tianqi Wen, Mountain View, CA (US); Weiqi Zhang, Mountain View, CA (US)

(21) Appl. No.: 18/284,909

(22) PCT Filed: Jul. 27, 2023
(86) PCT No.: PCT/US2023/028801

§ 371 Date: Sep. 29, 2023

(51) Int. Cl. G06Q 30/0241; G06Q 30/0273

(52) U.S. Cl. CPC G06Q 30/0277; G06Q 30/0275

(57) ABSTRACT

Systems, methods, and and/or algorithms facilitate the efficient provision of content to a client device, for filling content slots of an information resource having multiple content slots. A server receives, from a client device, a request for content to be included in the information resource and, in response, performs one or more content selection procedures to select one or more content items for one or more content slots. The server may, based on the results of the content selection procedure(s), conditionally perform or not perform one or more additional content selection procedures for one or more other content slots of the information resource. Alternatively or additionally, the server may, based on a format or content of one or more content items selected during the initial content selection procedure(s), apply one or more constraints to restrict which content items can be candidates in a one or more additional content selection procedures.

### FIELD OF TECHNOLOGY

The present disclosure relates to content selections procedures and, more specifically, to procedures for selecting content to be provided to a client device for presentation to a user within content slots of an information resource.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In some scenarios, such as when a user is visiting a web page or viewing a screen provided by a dedicated application, the user is presented with additional, dynamically-added content within certain reserved areas of the page or screen. For example, a web page may reserve one or more “slots” for third party content, and a client device may request that a server provide content items, such as digital advertisements or other third-party content items, to fill those slots. Typically, a client device sends the server a request for a given content slot, causing the server to perform a procedure to select a particular content item. The server then provides the selected content item to the client device, which populates/fills the slot with the content item. In the case of digital advertising, for example, the content selection procedure typically involves an auction. After some pre-filtering of advertisements (e.g., based on various targeting parameters), bidding scores and ranks are determined for the remaining candidates. A winner of the auction is determined based on the ranks, and the winner's advertisement is used to fill the content slot.

In cases where multiple content slots are available to be filled on a web page, user interface, or another information resource, various complexities may arise. For example, different slots and different content item formats may be associated with different priorities, and/or may have dependencies on (e.g., conflicts with) each other. As an example in the digital advertising context: to enhance or preserve the value of a prominent (e.g., top-of-page) ad slot, it may be preferable, when a sponsored content item (advertisement) is selected to fill that slot, to avoid putting another advertisement in a nearby slot, which could distract and/or annoy a user. In other examples, it may be preferable to avoid populating a single page with too many advertisements, and/or to avoid placing competing advertisements (e.g., for similar products) in adjacent slots of a page, etc. Accordingly, various decisions need to be made regarding whether to select particular advertisements, which advertisement slots should be filled, and/or whether to apply certain constraints on which advertisements can be candidates in an advertisement selection process.

In some existing systems, this decision-making process is performed by carrying out auctions for all available advertisement slots, and then determining whether to drop certain advertisements from among the auction winners. For example, in response to a request from a client device, a server may carry out a first auction for a first slot on a page and a second auction for a second slot on the same page. If the first auction has a certain result, such as the first slot being filled (or the first slot being filled by an ad for a particular product or brand, etc.), the winning advertisement for the second slot may be discarded; otherwise, the winning advertisement for the second slot is used to fill the second slot. This approach has certain technical drawbacks, however. First, because auctions are run for all requested slots (e.g., all slots on a page the user is visiting) but only a subset of the winning advertisements may be served to the user's device, there is typically a waste of processing resources. In particular, processing resources (e.g., processing time, processing power) at the server are wasted by running auctions even for slots where, ultimately, no advertisement is presented. Second, because advertisements for some slots may be dropped based on the result/winner for other slots, the advertisement slot “fill rate” may be diminished, resulting in inefficient provision of advertising content by the server (and thus, fewer impressions, lower ad revenue, etc.).

In other systems, the decision-making process is carried out by way of the client device making multiple remote procedure calls (RPCs) to the server, in sequence, to fetch advertisements for the different slots on a page. Under this approach, the client device makes a first RPC to the server for a first slot, and then waits for and considers the result/response obtained from the server before making a second RPC to the server for a second slot, etc. This approach, too, has significant drawbacks. First, because the client device must wait for the results from the server for each of the RPCs/slots in turn, with delays between each request and the response from the server, latency (e.g., web page load time) is increased, possibly to the point where it causes user annoyance. Second, because the client device must perform a substantial amount of front-end processing (e.g., to determine whether to make a subsequent RPC based on the result of a previous RPC), the processing load can result in client device crashes (e.g., browser or other application crashes), and therefore a poor user experience. This can be especially problematic when the client device is relatively memory-limited, such as may be the case with a smart television device, for example. Third, because the decision-making occurs at the client device, less information is generally available to the server, which can hamper the ability of the server to make future decisions (e.g., for future content selection) or provide useful analytics or troubleshooting feedback (e.g., information indicating advertisement performance, or information indicating why an advertisement was not served, etc.).

### SUMMARY

In some implementations described herein, a server determines whether to perform one or more content selection procedures to fill content slot(s) of an information resource, and/or the manner in which to perform the content selection procedure(s), based on the results from one or more earlier content selection procedures that were used to fill other content slot(s) of the information resource.

In one example implementation, a method for efficiently providing content to a client device includes receiving, by a server and from the client device, a request for content to be included in an information resource having a plurality of content slots and, in response to the request, selecting, by the server, one or more content items. Selecting the one or more content items includes (1) determining first content selection results for a first subset of the plurality of content slots, at least by using selection parameters associated with candidate content items to perform a first content selection procedure, and (2) based on the first content selection results, conditionally performing or not performing a second content selection procedure for a second subset of the plurality of content slots. The method also includes causing, by the server, the client device to fill one or more content slots, of the plurality of content slots, with the selected one or more content items.

In another example implementation, a method for efficiently providing content to a client device includes receiving, by a server and from the client device, a request for content to be included in an information resource having a plurality of content slots and, in response to the request, selecting, by the server, a plurality of content items. Selecting the plurality of content items includes (1) selecting a first set of one or more content items for a first subset of the plurality of content slots, at least by using selection parameters associated with candidate content items to perform a first one or more content selection procedures, and (2) based on a format or content of the first set of content items, applying one or more constraints to restrict which content items can be candidates in a second one or more content selection procedures for a second subset of the plurality of content slots. The method also includes causing, by the server, the client device to fill at least some of the plurality of content slots with the selected plurality of content items.

In some implementations, a server includes one or more processors and one or more memories, with the one or more memories storing instructions that, when executed by the one or more processors, cause the one or more processors to perform either of the above implementations.

### BRIEF DESCRIPTION OF THE DRAWINGS

FIG. 1 is a block diagram of an example system in which techniques for efficiently providing content to a client device can be implemented.

FIG. 2 depicts a first example information resource with content slots configured to display content items selected by content selection procedures.

FIG. 3 depicts a second example information resource with content slots configured to display content items selected by content selection procedures.

FIG. 4 is a message sequence diagram depicting an example implementation in which the content server of FIG. 1 selects content for, and provides the selected content to, the client device of FIG. 1.

FIG. 5 is a flow diagram of an example method for efficiently providing content to a client device.

FIG. 6 is a flow diagram of another example method for efficiently providing content to a client device.

### DETAILED DESCRIPTION OF THE DRAWINGS

Generally, in aspects of the disclosed invention, a server performs conditional content selection procedures. In particular, in response to receiving a request for content from a client device, the server performs one or more content selection procedures for filling one or more content slots of an information resource (e.g., a web page or an application screen/user interface displayed at the client device) and, for one or more additional content slots of the information resource, the server conditions the performance of content selection procedure(s) on the results of the earlier content selection procedure(s).

In certain exemplary implementations and scenarios described herein, the content items used to fill the content slots are advertisements, and/or the corresponding content selection procedures are auctions. However, the content items may instead be any other type of content that can be dynamically selected for presentation within an information resource, and the content selection procedures may instead be any other type of procedure suitable for selecting content (e.g., a procedure for selecting content based on relevancy scores of content items).

In one aspect of the invention, the server conditionally performs or does not perform one or more content selection procedures based on the results of one or more earlier content selection procedures for slots of the same information resource. In some implementations, for example, the server performs a second content selection procedure only when a first content selection procedure does not result in selection of any content item for a particular content slot. In other implementations, the server conditionally performs or does not perform the second content selection procedure based on one or more characteristics of a content item selected during the first content selection procedure. For example, the server may use a machine learning model to determine a relevancy score of a content item selected during the first content selection procedure, and then perform the second content selection procedure only if the relevancy score exceeds some predetermined threshold.

In another aspect of the invention, the server instead, or also, conditions the manner in which one or more content selection procedures are performed on the result of one or more earlier content selection procedures for slots of the same information resource. In particular, the server can apply one or more constraints based on the format and/or content of a content item selected during a first content selection procedure, where the constraint(s) serve to restrict which content items can be candidates in a second content selection procedure. In various implementations, for example, the server may exclude content items from the second content selection procedure based on a category or format of those content items (e.g., based on whether the category or format of the content items is the same as a content item resulting from the first content selection procedure), based on user cost, based on a level of similarity between the content items and a content item selected during the first content selection procedure, and/or based on other factors.

For either of the two aspects described above, the server may, in some implementations, sort content slots of the information resource according to their priority levels before performing the first content selection procedure, in order to determine the order in which the server should attempt to fill content slots. In some implementations, at least some content slots of the information resource may be grouped together, in which case the server may perform content selection procedures for the content items within a given group at least partially in parallel with each other.

These and other aspects can improve efficiency of content selection procedures (e.g., use less processing resources), reduce latency (e.g., reduce loading time for a web page), prevent “crashes” at the client device (e.g., if the client device is a highly resource-constrained device), and/or provide other technical advantages.

For example, in the first aspect (where the server conditionally performs or does not perform one or more additional content selection procedures for an information resource), (1) the server uses less processing resources than would be the case if the server automatically performed content selection procedures for all content slots in a multi-slot information resource (e.g., based on a single request from a client device), (2) latency or delay is reduced at the client device (e.g., when loading a web page with multiple content slots) as compared to cases where a client device must send a series of separate requests to the server for different slots, and/or (3) crashes are less likely to occur at the client device as compared to cases where the client device must process the response to each of a series of separate requests sent to the server in order to determine whether to send a next request.

In the second aspect (where the server conditions the manner in which one or more additional content selection procedures are performed on the results of one or more earlier content selection procedures for the same information resource), (1) the fill rate for content item slots is generally increased as compared to cases where the server automatically performs content selection procedures for all content slots in a multi-slot information resource (e.g., based on a single request from a client device), (2) latency or delay is reduced at the client device (e.g., when loading a web page with multiple content slots) as compared to cases where a client device must send a series of separate requests to the server for different slots, and/or (3) crashes are less likely to occur at the client device as compared to cases where a client device must process the response to each of a series of separate requests sent to the server in order to determine whether to send a next request.

Furthermore, in both of these aspects, more information is generally available to the server as compared to cases where a client device makes multiple content requests, and analyzes each request result/response, for the slots of a given information resource. Such information can help the server to make better-informed decisions (e.g., for future content selection) and/or allow the server to provide useful analytics or troubleshooting feedback (e.g., information indicating advertisement performance, or information indicating why an advertisement was not served, etc.).

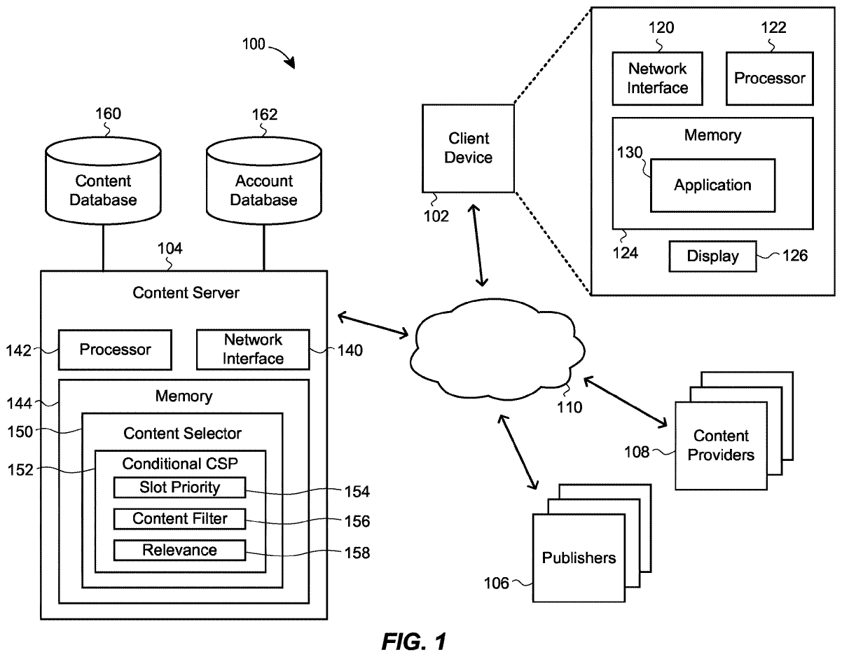

FIG. 1 illustrates an example system 100 in which one or more techniques for efficiently providing content to a client device 102 may be implemented. The example system 100 includes the client device 102, a content server 104, a number of publishers 106, a number of content providers 108, and a network 110. The content server 104 is remote from the client device 102, and is communicatively coupled to the client device 102 via the network 110. The communicative/network connections shown in FIG. 1 for publishers 106 and content providers 108 represent communicative/network connections with computing devices or systems that are associated with the publishers 106 and content providers 108, respectively.

The network 110 may be a single communication network (e.g., the Internet), and in some implementations also includes one or more additional networks. As just one specific example, the network 110 may include a cellular network, the Internet, and a server-side local area network (LAN). While FIG. 1 shows only a single client device 102, it is understood that the content server 104 may also be in communication with a number of other client devices that are generally similar to the client device 102.

Generally, the client device 102 can access information resources supplied or published by publishers 106, and content server 104 selects content items provided by content providers 108 to populate content slots within those information resources. For example, the information resources may be web pages of websites hosted by publishers 106, and content providers 108 may provide advertisements or other content items that the content server 104 can then select for filling content slots within those web pages. As another example, the information resources may be screens or user interfaces of applications (e.g., mobile apps) provided by the publishers 106, and content providers 108 may provide advertisements or other content items that the content server 104 can use to populate content slots within those user interfaces. As yet another example, the information resources may be videos, and the content slots may be distributed in time throughout the videos. In some implementations, however, multiple (some or all) content slots of an information resource are simultaneously present in the information resource, with no temporal distribution. The content items themselves may be text, images, or video, or any combination thereof, and may or may not include audio components.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable on the processing unit 122 to perform various operations, including the instructions of various software applications and the data generated and/or used by such applications. In the example implementation of FIG. 1, the memory 124 stores at least an application 130, which may be, for example, a web browser application (e.g., Chrome), or a mobile application downloaded from an application store.

Generally, the application 130 is executed by the processor 122 to present information resources to the user of the client device 102 via the display 126, with at least one of those information resources including multiple content slots for dynamically presenting content items. In an implementation where the application 130 is a web browsing application, for instance, an information resource may be a web page hosted by one of the publishers 106, with the browser causing the client device 102 to download HTML, scripts, and/or other code of the web page for presentation to a user via the display 126. As another example, the application 130 may be a video sharing application such as YouTube, and the information resource may be a user interface generated by the video sharing application and presented via the display 126. As yet another example, the application 130 may be a video playing application, and the information resource may be a video played by the video playing application.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the content server 104 via the network 110. For example, the network interface 120 may include a cellular communication transceiver, a WiFi transceiver, and/or transceivers for one or more other wired and/or wireless communication technologies.

While FIG. 1 shows client device 102 as a single component communicating directly (i.e., via network 110) with the content server 104, in some implementations the subcomponents of client device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

The content server 104 includes a network interface 140, a processor 142, and memory 144. The network interface 140 includes hardware, firmware, and/or software configured to enable the content server 104 to exchange electronic data with the client device 102 and other, similar client devices via the network 110. For example, the network interface 140 may include a wired or wireless router and a modem. The processor 142 may be a single processor, or may include two or more processors. As used herein, the term “server” can refer to a single computing device at a single location, or to multiple, coordinating computing devices that are either co-located or remotely distributed.

The memory 144 is a computer-readable, non-transitory storage unit or device, or collection of units/devices, that may include persistent and/or non-persistent memory components. The memory 144 stores the instructions of a content selector 150, which may be executed by the processor 142. The content selector 150 includes a conditional content selection procedure (CSP) module 152 that includes a slot priority module 154, a content filter 156, and a relevance module 158. One, some, or all of the modules 154, 156, and 158 can optionally be omitted from the system 100.

Generally, the content selector 150 selects content items that the content server 104 then provides/sends to the client device 102 (or to other client devices) via the network 110. The content selector 150 selects particular content items using one or more content selection procedures implemented by the conditional CSP module 152. The content filter 156 can apply one or more constraints to restrict which content items can serve as candidates for selection by the conditional CSP module 152, based on the results of one or more earlier content selection procedures (as discussed further below) and/or based on one or more other factors (e.g., user preferences).

The content selection procedures executed by the conditional CSP module 152 may be auctions, for example, with the conditional CSP module 152 selecting a winner based on bid amounts that various content providers 108 provide to the content server 104, or bid amounts that the content server 104 otherwise generates for the various content providers 108 (e.g., based on inputs from the content providers 108 such as preferred maximum bid amounts). As a more specific example, each content provider 108 may offer a maximum bid amount for placement of its content item, and the conditional CSP module 152 may select the content item associated with the content provider 108 having the highest bid. The content server 104 may then charge that highest bid amount (or the amount bid by the second-highest bidder, etc.) to the winning content provider 108, and select the content item associated with that content provider 108 to fill the content slot under consideration.

The content selection procedures may also, or instead, account for selection parameters other than bid amounts, such as the relevance of particular content items to a user of the client device 102 (or relevance to the information resource, etc.) as determined by the relevance module 158, and/or user preferences, etc. The content selection procedures may be entirely rules-based, or may have one or more random components (e.g., random selection from a pool of candidates after filtering by content filter 156), etc.

At least some of the content selection procedures performed by the conditional CSP module 152 have a conditional aspect. In some implementations, for example, performance of a content selection procedure for a given content slot or slots is conditioned on the results of the content selection procedure for one or more other content slots in the same information resource. Additionally or alternatively, in some implementations, the content filter 156 may conditionally apply or not apply one or more constraints restricting which content items can be candidates for selection for one or more content slots based on the results of content selection procedures for one or more other content slots in the same information resource. In some implementations, the slot priority module 154 determines the priority/ordering of individual content slots, or of groups/subsets of content slots, and the conditional CSP module 152 performs the conditional content selection procedures for one, some, or all of the content slots or content slots subsets in accordance with the determined ordering.

The operation of the conditional CSP module 152 and its constituent modules is discussed in further detail below, in connection with various example implementations.

The content items provided (e.g., created and/or sourced) by content providers 108 and available for selection by the content selector 150 may be stored, in some implementations, in a content database 160. The content database 160 may be stored in the memory 144, or may be stored in one or more memories that are remote from the content server 104, for example.

In some implementations, the publishers 106 and/or content providers 108 hold accounts related to the services provided by the content server 104. For example, the publishers 106 may create such accounts in order to monetize information resources that they publish or otherwise make available (e.g., by selling advertising in content slots on the publishers'hosted web pages), and/or the content providers 108 may create such accounts in order to locate and purchase content slots in which it would be particularly advantageous to present their content (e.g., advertisements). In these implementations, information associated with the publisher and/or content provider accounts may be stored in an account database 162. The account database 162 may be stored in the memory 144, or may be stored in one or more memories that are remote from the content server 104, for example. The account information may include information such as entity name, subscription level, entity preferences (e.g., brand control preferences), and so on. In some implementations, the account information includes selection parameters (e.g., bid amounts or maximum bid amounts) associated with different content providers 108, for use by the conditional CSP module 152 in selecting content as discussed elsewhere herein.

In some implementations, the system 100 is arranged in a manner different than that shown in FIG. 1. For example, the content server 104 may be associated with the same entity that sources the information resources, in which case the system 100 may omit the publishers 106 (e.g., activities described herein for the publishers 106 may instead be performed by the content server 104). Additionally or alternatively, the content server 104 may be associated with the same entity that sources content items for populating content slots in the information resources, in which case the system 100 may omit the content providers 108 (e.g., activities described herein for the content providers 108 may instead be performed by the content server 104).

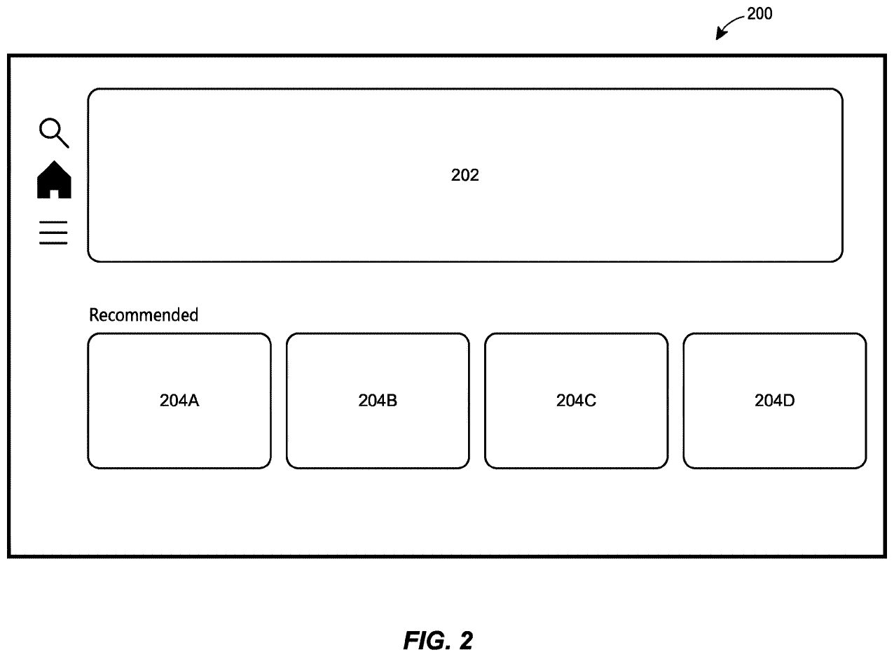

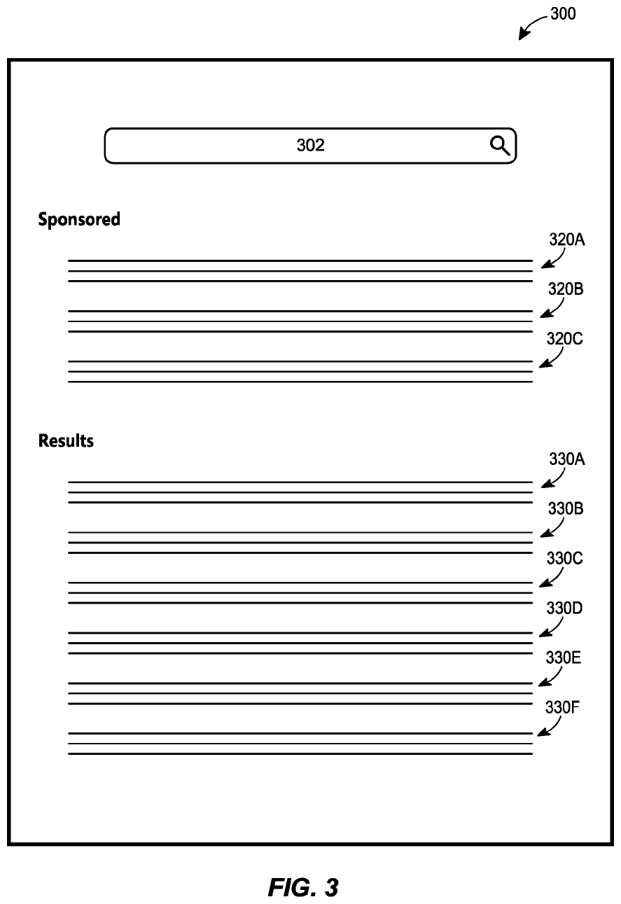

FIGS. 2 and 3 depict example information resources having content slots for which the content selector 150 of FIG. 1 is configured to select content items. The information resource of FIG. 2 or FIG. 3 may be sourced (e.g., hosted) by one of publishers 106, and presented on the display 126 by the application 130 after the client device 102 downloads the information resource (e.g., from a publisher 106) via the network 110 and network interface 120, for example.

FIG. 2 depicts an information resource 200 that is a user interface for a video sharing application (e.g., YouTube), where the user interface may be provided as a web page (e.g., if application 130 is a web browser) or as a screen of a dedicated application (e.g., if application 130 is a dedicated video sharing application). The information resource 200 includes a primary or “masthead” content slot 202, and secondary content slots 204A-D, with the primary content slot 202 being more prominent both by being at a higher position within the information resource 200, and by having larger dimensions (height and/or width), relative to each of the secondary content slots 204A-D.

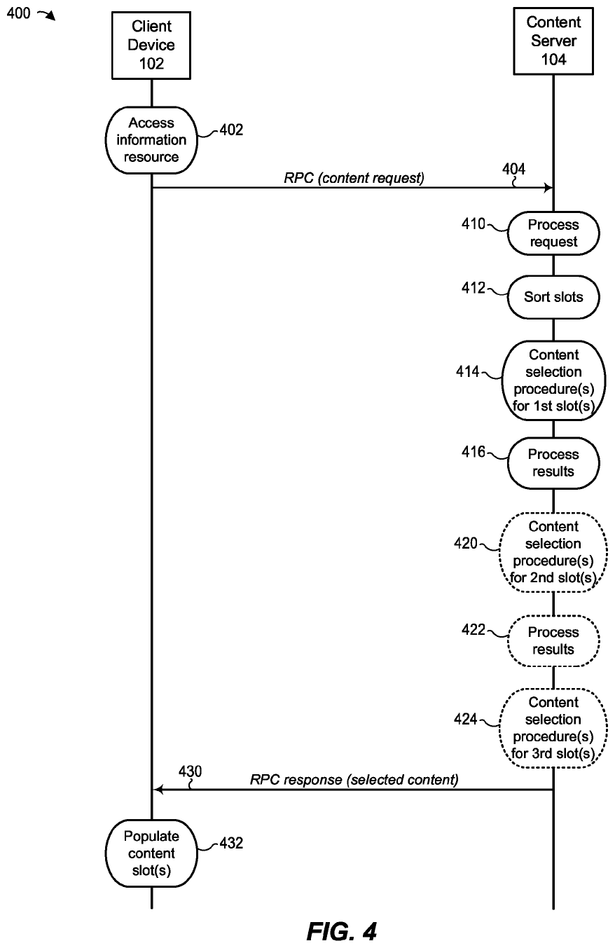

In some implementations where the application 130 is a web browser application and the information resource 200 is a web page hosted by one of publishers 106, the application 130 downloads and executes code (e.g., HTML code) of the web page in order to present the web page via display 126. The web page code may also include a script (e.g., JavaScript) that, when interpreted by the application 130, causes the client device 102 to request, from the content server 104, content to fill or conditionally fill at least some of (i.e., two or more of) the content slots 202 and 204A-D. In some implementations where application 130 is instead a dedicated application that generates the information resource 200, the application 130 causes the client device 102 to request content from the content server 104 when the information resource 200 is first generated (e.g., when the application 130 launches). In either case (web page or dedicated application screen), the request sent to the content server 104 may be a single remote procedure call (RPC), as discussed below in connection with FIG. 4.

FIG. 3 depicts an information resource 300 that is a user interface for a search engine, where the user interface may be provided as a web page (e.g., if application 130 is a web browser) or as a screen of a dedicated application (e.g., if application 130 is a search engine mobile application). The information resource 300 includes a number of sponsored content slots 320A-C, with each successive slot being further down within a list presented on the information resource 300, followed by a number of content slots 330A-F representing results of a search. The search may be based on a text string query entered by the user in a query field 302. In various implementations, the search results (e.g., uniform resource locator (URL) links) used to populate content slots 330A-F may be selected by the content server 104 or a server other than content server 104 (e.g., a dedicated search engine server), using any suitable search techniques or algorithms.

In some implementations where the application 130 is a web browser application and the information resource 300 is a web page, the application 130 downloads and executes code (e.g., HTML code) of the web page in order to present the web page via display 126. The web page code may also include a script (e.g., JavaScript) that, when interpreted by the application 130, causes the client device 102 to request, from the content server 104, content to fill or conditionally fill at least content slots 320A-C. In some implementations where application 130 is instead a dedicated application that generates the information resource 300, the application 130 causes the client device 102 to request content from the content server 104 when the information resource 300 is first generated (e.g., when the application 130 launches). In either case (web page or dedicated application screen), the request sent to the content server 104 may be a single RPC as discussed below in connection with FIG. 4.

In some implementations, the information resource 300 presents results in a different manner than shown in FIG. 3. For example, the search engine may utilize generative artificial intelligence (e.g., based on a large language model (LLM)), and the information resource 300 may, instead of providing an ordered list of search results, provide a single, paragraph-style text response to the user's query. In one such implementation, sponsored content slots 320A-C are interspersed in the generated text response at fixed or dynamically varying locations.

In some implementations, the content slots 202 and 204A-D of FIG. 2, or the content slots 320A-C of FIG. 3, are all configured to display content of the same general type (e.g., video only, image only, text only, or text and images, etc.). In other implementations, different content slots of the same information resource can display content of different types, depending on which content is selected for the slots by the content server 104. For example, the content selector 150 may be constrained (by content filter 156) to only select a video content item for content slot 202, but be able to select either image (or image and text, etc.) or video (or video and text, etc.) content items for the remaining content slots 204A-D.

In some implementations, when one of content slots 202, 204A-D, 320A-C has been filled with a content item, a user of the client device 102 can select that content item using an input device of the client device 102 (e.g., by tapping a touchscreen, clicking a mouse button, etc.) to transfer to a page or other information resource associated with the selected content item. For example, if the content item is an advertisement that populates content slot 202 or 204A in FIG. 2, or content slot 320A in FIG. 3, a user selection of that content item may cause the application 130 to direct the user to a landing page hosted by a server of the content provider. The landing page may allow the user to navigate to a page that enables the user to purchase an item advertised by the content item, for example. In implementations where the initial information resource (200 or 300) is a web page, this may include transferring the user from the initial web page URL to the content provider's URL/web page. In implementations where the initial information resource (200 or 300) is a dedicated application screen, this may include automatically opening a web browser application and opening the URL of content provider's web page.

It is to be understood that FIGS. 2 and 3 are for illustrative purposes only, and that the techniques described herein can instead apply to information resources with different numbers of content slots, different sizes of content slots, different relative positions of content slots, and so on. Moreover, a user may be required to navigate across the information resource (e.g., by scrolling or panning) to view certain content slots, in some implementations and/or scenarios. In some implementations, the multiple content slots are distributed over time (e.g., if the information resource is a video, with multiple slots for video advertisement breaks).

The manner in which the content selector 150 selects content items to fill/populate the content slots 202, 204A-D of FIG. 2 or the content slots 320A-C of FIG. 3, according to some implementations, will now be described with reference to FIG. 4. FIG. 4 depicts an example scenario 400 in which the content server 104 of FIG. 1 selects content for, and provides content to, the client device 102 of FIG. 1. In the scenario 400, the client device 102 accesses 402 an information resource having multiple content slots (e.g., information resource 200 or 300). In implementations where the information resource is a web page hosted by one of the publishers 106, event 402 may include the client device 102 using a URL of the web page to access the web page (possibly after the user navigates a website of the publisher 106), at least in part by receiving the code of the web page (e.g., HTML, JavaScript, etc.) via the network 110 from the publisher 106. In implementations where the information resource is a user interface/screen of the (dedicated) application 130, event 402 may include the client device 102 launching the application 130, and possibly navigating to a particular user interface provided by the application 130.

After (e.g., automatically and in response to) accessing 402 the information resource, the client device 102 (e.g., application 130) requests 404 content from the content server 104 to populate content slots of the information resource. The request may consist of a single RPC. In some implementations where the information resource is a web page, event 404 may be automatically triggered by the application 130 in response to the application 130 interpreting a script that is embedded in the web page code received from the server hosting the web page. In some implementations where the information resource is a user interface/screen of a dedicated application (application 130), event 404 may be automatically triggered by the application 130 in response to the user opening or launching the application 130, or in response to the user navigating to a particular user interface/screen of the application 130. Other triggers for event 404 are also possible.

In response to receiving the request, the content server 104 (e.g., content selector 150) processes 410 the request. Event 410 may include, for example, reformatting the request message, and/or determining capabilities of the client device 102 based on the request message, etc. In some implementations, event 410 is omitted. The slot priority module 154 sorts 412 content slots of the information resource (e.g., slots 202 and 204A-D of FIG. 2 or slots 320A-C of FIG. 3) according to slot priority. The sorting 412 serves to establish an order in which the conditional CSP module 152 will execute, or consider executing, content selection procedures for specific content slots or specific content slot subsets. The slot priority module 154 may sort 412 the slots or slot subsets of the information resource based on priority information sent to the content server 104 by the client device 102 (e.g., in the request message at event 404). The client device 102 may have obtained the priority information from the information resource, from information (e.g., a flag or field value) associated with each content slot or slot subset, and/or from the application 130, for example. In some implementations, the order/priority is fixed, and event 412 is omitted.

The priority information may reflect the desirability (e.g., prominence of position, size, etc.) of content slots. For the information resource 200, for example, content slot 202 may have highest priority, content slot 204A second highest priority, content slot 204B third highest priority, content slot 204C fourth highest priority, and content slot 204D fifth highest priority. Alternatively, content slot 202 may have the highest priority, while content slots 204A-D are grouped together and all have the same, second highest priority. For the information resource 300, content slot 320A may have the highest priority, content slot 320B the second highest priority, and content slot 320C the third highest priority. Other priorities and/or groupings are also possible.

At event 414, the conditional CSP module 152 performs a content selection procedure (e.g., auction, or relevance-based selection procedure, etc.) for the content slot having the highest priority (e.g., content slot 202 or 320A), or performs a first set of content selection procedures for respective slots of a subset of content slots having the highest priority (e.g., content slots 302A and 302B). The conditional CSP module 152 then processes 416 the results of the content selection procedure(s) performed at event 414 in order to determine how, or whether, conditional selection procedure(s) should be performed for the next-highest priority content slot or slot subset at event 420.

In some implementations, at event 416, the conditional CSP module 152 decides whether to perform or not perform event 420 (and possibly, any other subsequent, similar operations, such as event 424) based on the results. For example, the conditional CSP module 152 may (1) determine that no content selection procedure (e.g., auction) is to be performed for content slot 204A if a content selection procedure at event 414 resulted in a content item of any sort being selected for content slot 202, but (2) determine that the content selection procedure should be performed if the content selection procedure at event 414 resulted in no content item of any sort being selected for content slot 202. As another example, the conditional CSP module 152 may (1) determine that no content selection procedure is to be performed for any of content slots 204A-D if the content selection procedure at event 414 resulted in a content item being selected for content slot 202, but (2) determine that content selection procedures for each of content slots 204A-D should be performed if the content selection procedure at event 414 resulted in no content item being selected for content slot 202. As yet another example, the conditional CSP module 152 may (1) determine that no content selection procedure is to be performed for content slot 320B if the content selection procedure at event 414 resulted in a content item being selected for content slot 320A, but (2) determine that the content selection procedure should be performed if the content selection procedure at event 414 resulted in no content item being selected for content slot 320A.

A content selection procedure performed by the conditional CSP module 152 may fail to result in a content item being selected for a particular content slot for various reasons, depending on the implementation and scenario. For example, a content selection procedure may result in a content item that is rejected by the content server 104 due to security concerns relating to the content item (e.g., suspect scripts within the content item), or due to incompatibility with preferences of the user of the client device 102 or the publisher 106 (e.g., if the content filter 156 applies certain constraints after content selection procedures are completed), and so on.

In other implementations, the processing at event 416 analyzes other aspects of the results of the content selection procedure(s) at event 414 when determining whether to perform or not perform event 420 (and/or subsequent events in FIG. 4). For example, the conditional CSP module 152 may determine that no content selection procedure is to be performed for any of content slots 204A-D if a content selection procedure for content slot 202 at event 414 resulted in a content item being selected with a bid over a certain minimum dollar amount. In another implementation, the conditional CSP module 152 may determine whether to perform the content selection procedure(s) at event 414 based on one or more characteristics of one or more content items selected at event 414. For example, the conditional CSP module 152 may determine that no content selection procedure is to be performed for any of content slots 204A-D at event 420 if the content selection procedure at event 414 resulted in a content item of a particular type (e.g., video) being selected for content slot 202.

In another example implementation, the conditional CSP module 152 conditionally performs or does not perform the content selection procedure(s) at event 420 based on a relevancy score of at least one content item selected during a content selection procedure (or procedures) at event 414. For example, the relevance module 158 (or another module/software, or possibly another server) may use a machine learning model (e.g., neural network) to determine a relevancy score for each of one or more content items selected at event 414, and the relevance module 158 may perform the content selection procedure(s) at event 420 only if the determined relevancy score (or each of a certain number of relevancy scores) exceeds some predetermined threshold. The relevancy score may be indicative of relevance to the user's search query (e.g., text string), for example, or relevance to the information resources, etc.

As a more specific example, in a scenario where the information resource 200 is presented to a user of client device 102 in response to the user's video search query, the relevance module 158 may use a machine learning model to calculate a relevancy or search score for a content item selected by content selector 150 (at event 414) to fill content slot 202. If the relevancy/search score is greater than some threshold value (meaning the content item is highly relevant to the search), the conditional CSP module 152 runs another content selection procedure (e.g., auction) at event 420 to fill content slot 204A (or runs such procedures for each of slots 204A-D). If the search score of the content item is not greater than the threshold, however, the conditional CSP module 152 does not run the content selection procedure(s) at event 420, to lower the likelihood of annoying the user with irrelevant or useless information.

In some implementations, at event 416, the conditional CSP module 152 instead (or additionally) determines the manner in which event 420 is to be performed based on the results of the content selection procedure(s) at event 414. In particular, the content filter 156 may, based on a format or content of the content item(s) selected at event 414, apply one or more constraints to restrict which content items (from content database 160) can serve as candidates in the content selection procedure(s) at event 420.

For example, the conditional CSP module 152 may exclude content items from consideration at event 420 based on a category of one or more content items selected at event 414, a user cost associated with one or more of the selected content items, a format of one or more of the selected content items (e.g., excluding content items having the same format as a selected content item), and/or a level of similarity to one or more of the selected content items. A level of similarity may be indicated by a similarity score. The content server 104 (e.g., content selector 150) may determine similarity scores for pairs of content items using machine learning techniques, such as neural networks or other machine learning models that are trained on content item pairs using supervised or unsupervised learning techniques. The machine learning models may operate (accept as inputs) certain parameters indicating characteristics of the content items (e.g., content item format, category, length, etc.), or may operate directly on image, text, or video frame information, for example. In some implementations, the content server 104 uses generative artificial intelligence (e.g., large language models (LLMs)) to determine the level of similarity between two content items that both include text.

By applying constraints based on categories or formats of earlier-selected content items, and/or based on similarity to earlier-selected content items, scenarios in which too many content items of a particular type/format/etc. are selected can be avoided, providing various benefits. For example, if the content slots correspond to in-stream video advertisement breaks, it may be desirable to avoid subjecting client device users to multiple long video advertisements (e.g., over some threshold length, such as 60 seconds). Thus, the content filter 156 may exclude (as candidates for content selection procedure(s) at event 420) any long video advertisements (e.g., over the threshold length) for one or more subsequent advertisement breaks if a long video advertisement was selected for the first break. As another example, the content filter 156 may help to enforce brand safety constraints associated with advertisements or content providers. For example, the content filter 156 may exclude (as candidates for content selection procedure(s) at event 420) any advertisements associated with competitors of a content provider whose advertisement was selected at event 414. A list of competitors may be associated with the account of each content provider 108 in account database 162, or the content server 104 may access other information (e.g., categories of goods or services sold as indicated in database 160 or 162) to identify likely competitors, etc.

In some implementations, the content filter 156 uses a machine learning model to apply its constraints to content items. For example, event 420 may include applying one or more parameters indicative of the format or content of the content item(s) selected at event 414 as inputs to a machine learning model (e.g., neural network), and deriving at least one of the constraints from an output of the machine learning model.

As seen in FIG. 4, additional events similar to events 416 and/or 420 may occur, or conditionally occur, if there are subsequent priority levels of content slots (or slot subsets) as determined by slot priority module 154. For example, the conditional CSP module 152 may process the results of the content selection procedure(s) of event 420 at event 422 (e.g., similar to event 416), and conditionally perform or not perform (or conditionally apply constraints to the performance of) one or more further content selection procedures at event 424 (e.g., similar to event 420), and so on.

In some implementations where certain content slots (e.g., slots 204A-D) are grouped together into subsets for purposes of prioritizing/sorting, the conditional CSP module 152 performs the content selection procedures for all content slots within the group/subset in parallel (i.e., simultaneously), or at least partially in parallel (i.e., at least partially overlapping in time), in order to reduce latency associated with populating the content slots of the information resource.

After events 410 through 424 are complete (or possibly not performed at all in the case of event 420 through 424, as discussed above), the content server 104 responds 430 (e.g., returns an RPC response) to the client device 102. The response of event 430 may include the content item(s) selected during the one or more content selection procedures of events 414, 420, 424, or may include links to the selected content item(s). At event 430, the client device 102 populates the appropriate content slot(s) of the information resource with the selected content item(s). In some implementations, the client device 102 need not make any RPCs other than the single RPC of event 404 in order to obtain the content item(s) for populating the slots of the information resource.

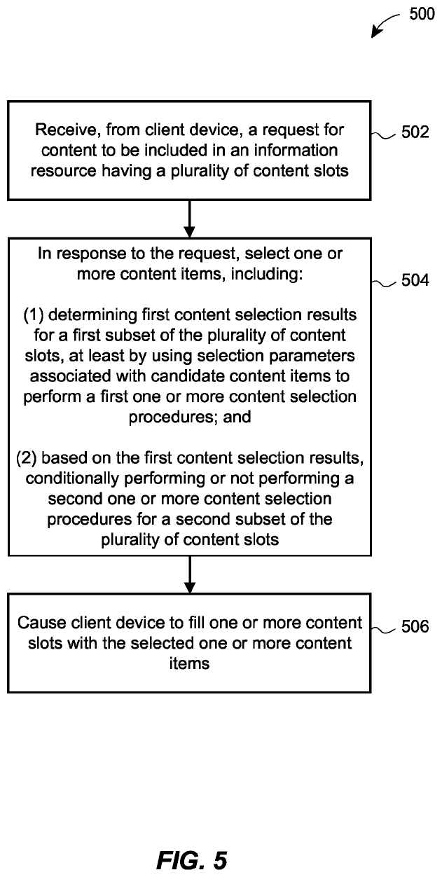

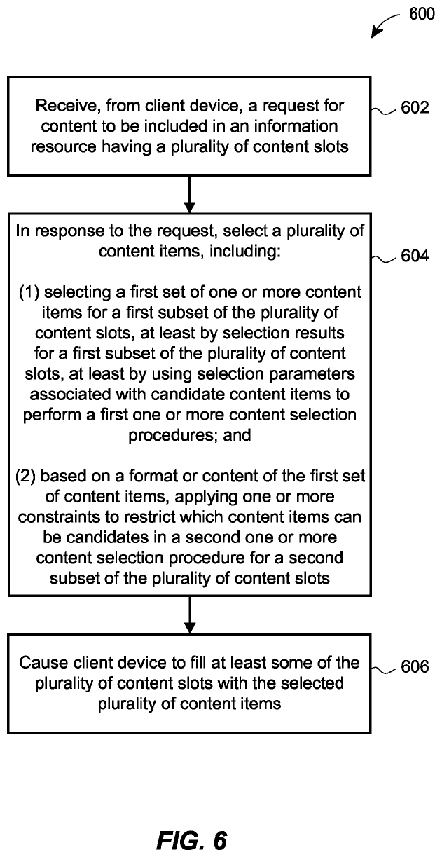

Example methods for efficiently selecting content for a client device will now be discussed with reference to FIGS. 5 and 6. Either or both of the methods of FIGS. 5 and 6 may be implemented as instructions stored on one or more computer-readable media and executed on one or more processors in one or more computing devices. For example, the method(s) may be implemented by the processor 142 of the content server 104 in FIG. 1, when executing instructions of the content selector 150.

Referring first to the method 500 of FIG. 5, a request for content to be included in an information resource having a plurality of content slots is received (e.g., event 404) from a client device (e.g., client device 102) at block 502. At block 504, in response to the request, one or more content items are selected. Block 504 includes determining first content selection results for a first subset of the plurality of content slots (e.g., event 414), at least by using selection parameters associated with candidate content items (e.g., bid amounts, relevancy scores, etc.) to perform a first one or more content selection procedures. Block 504 also includes, based on the first content selection results, conditionally performing or not performing a second one or more content selection procedures for a second subset of the plurality of content slots. In some implementations, the first subset of the plurality of content slots consists of only a single content slot, and/or the second subset of the plurality of content slots consists of only a single content slot. In other implementations, one or both subsets include multiple content slots.

At block 506 the client device is caused to fill one or more content slots, of the plurality of content slots, with the selected one or more content items. Block 506 may correspond to event 430, for example.

In some implementations, block 504 includes refraining from performing (not performing) the second content selection procedure(s) when selecting a first set of one or more content items to fill the first subset of the plurality of content slots, and instead performing the second content selection procedure(s) when not selecting any content items to fill the first subset of the plurality of content slots.

In some implementations, determining the first content selection results at block 504 includes selecting a first set of one or more content items to fill the first subset of the plurality of content slots, and selecting the one or more content items at block 504 includes conditionally performing or not performing the second content selection procedure(s) based on one or more characteristics of the first set of content items. The one or more characteristics of the first set of content items may include one or more relevancy scores associated with the first set of content items (e.g., as determined by the relevance module 158 using a machine learning model).

In some implementations, the method 500 also includes, before selecting the one or more content items, determining that the first subset has a higher priority than the second subset, and performing the first content selection procedure(s) at block 504 is performed in response to this determination.

In some implementations, the first subset of the plurality of content slots includes at least a first content slot and a second content slot, the first content selection procedure(s) includes a third content selection procedure for the first content slot and a fourth content selection procedure for the second content slot, and performing the first content selection procedure(s) includes performing the third content selection procedure at least partially in parallel with performing the fourth content selection procedure.

Referring next to the method 600 of FIG. 6, a request for content to be included in an information resource having a plurality of content slots is received (e.g., event 404) from a client device (e.g., client device 102) at block 602. At block 604, in response to the request, a plurality of content items is selected. Block 604 includes selecting a first set of one or more content items for a first subset of the plurality of content slots (e.g., slot 202, slot 320A, or slots 320A and 320B, etc.), at least by using selection parameters (e.g., bids, relevancy scores, etc.) associated with candidate content items to perform a first one or more content selection procedures (e.g., event 414). Block 604 also includes applying, based on a format or content of the first set of content items, one or more constraints to restrict which content items can be candidates in a second one or more content selection procedures for a second subset of the plurality of content slots. In some implementations, the first subset of the plurality of content slots consists of only a single content slot, and/or the second subset of the plurality of content slots consists of only a single content slot. In other implementations, one or both subsets include multiple content slots.

At block 606 the client device is caused to fill at least some of the plurality of content slots with the selected content items. Block 606 may correspond to event 430, for example.

In some implementations, applying the one or more constraints includes excluding content items from the second content selection procedure(s) based on content item category (e.g., excluding content items associated with a category of at least one content item of the first set of content items), excluding content items from the second content selection procedure(s) based on a user cost associated with at least one content item of the first set of content items, excluding content items having a same format as at least one content item of the first set of content items, and/or excluding content items based on similarity scores that indicate a level of similarity to at least one content item of the first set of content items. In the latter case, the method 600 may further include determining the similarity scores using a machine learning model.

In some implementations, applying the constraint(s) at block 604 includes applying one or more parameters indicative of the format or content of the first set of content items as inputs to a machine learning model, and deriving at least one of the constraint(s) from an output of the machine learning model.

In some implementations, the method 600 also includes, before selecting the content items at block 604, determining that the first subset has a higher priority than the second subset, and performing the first content selection procedure(s) at block 604 is in response to determining that the first subset has the higher priority.

In some implementations, the first subset of content slots includes at least a first content slot and a second content slot, the first content selection procedure(s) include a third content selection procedure for the first content slot and a fourth content selection procedure for the second content slot, and performing the first content selection procedure(s) at block 604 includes performing the third content selection procedure at least partially in parallel with performing the fourth content selection procedure.

In some implementations, the techniques disclosed herein use artificial intelligence to facilitate the efficient selection of content items to fill content slots in an information resource. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the content server 104 (e.g., the conditional CSP module 152) may use any one or more the machine learning models noted above to perform any one or more of the operations discussed herein in connection with machine learning. For example, the content server 104 may use one or more such machine learning models to determine relevancy scores of content items, to determine similarity scores between content items, and/or to determine constraints to be applied by the content filter 156, as discussed above.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1. A method for efficiently providing content to a client device, the method comprising: receiving, by a server and from the client device, a request for content to be included in an information resource having a plurality of content slots; in response to the request, selecting, by the server, one or more content items, including (i) determining first content selection results for a first subset of the plurality of content slots, at least by using selection parameters associated with candidate content items to perform a first one or more content selection procedures, and (ii) based on the first content selection results, conditionally performing or not performing a second one or more content selection procedures for a second subset of the plurality of content slots; and causing, by the server, the client device to fill one or more content slots, of the plurality of content slots, with the selected one or more content items.

Example 2. The method of example 1, wherein selecting the one or more content items includes: not performing the second one or more content selection procedures when selecting a first set of one or more content items to fill the first subset of the plurality of content slots; and performing the second one or more content selection procedures when not selecting any content any content items to fill the first subset of the plurality of content slots.

Example 3. The method of example 1, wherein: determining the first content selection results includes selecting a first set of one or more content items to fill the first subset of the plurality of content slots; and selecting the one or more content items includes conditionally performing or not performing the second one or more content selection procedures based on one or more characteristics of the first set of content items.

Example 4. The method of example 3, wherein the one or more characteristics of the first set of content items includes one or more relevancy scores associated with the first set of content items.

Example 5. The method of example 4, further comprising: determining, by the server, the one or more relevancy scores using a machine learning model.

Example 6. The method of any one of examples 1-5, further comprising: before selecting the one or more content items, determining, by the server, that the first subset has a higher priority than the second subset, wherein performing the first one or more content selection procedures is in response to determining that the first subset has a higher priority than the second subset.

Example 7. The method of example 6, wherein: the first subset of the plurality of content slots includes at least a first content slot and a second content slot; the first one or more content selection procedures includes a third content selection procedure for the first content slot and a fourth content selection procedure for the second content slot; and performing the first one or more content selection procedures includes performing the third content selection procedure at least partially in parallel with performing the fourth content selection procedure.

Example 8. The method of any one of examples 1-6, wherein one or both of: the first subset of the plurality of content slots consists of a single content slot; and the second subset of the plurality of content slots consists of a single content slot.

Example 9. The method of any one of examples 1-8, wherein the request is a remote procedure call (RPC).

Example 10. A method for efficiently providing content to a client device, the method comprising: method for efficiently providing content to a client device, the method comprising: receiving, by a server and from the client device, a request for content to be included in an information resource having a plurality of content slots; in response to the request, selecting, by the server, a plurality of content items, including selecting a first set of one or more content items for a first subset of the plurality of content slots, at least by using selection parameters associated with candidate content items to perform a first one or more content selection procedures, and based on a format or content of the first set of content items, applying one or more constraints to restrict which content items can be candidates in a second one or more content selection procedures for a second subset of the plurality of content slots; and causing, by the server, the client device to fill at least some of the plurality of content slots with the selected plurality of content items.

Example 11. The method of example 10, wherein applying the one or more constraints includes: excluding content items from the second one or more content selection procedures based on content item category.

Example 12. The method of example 11, wherein excluding content items from the second one or more content selection procedures based on content item category includes: excluding content items associated with a category of at least one content item of the first set of content items.

Example 13. The method of any one of examples 10-12, wherein applying the one or more constraints includes: excluding content items from the second one or more content selection procedures based on a user cost associated with at least one content item of the first set of content items.

Example 14. The method of any one of examples 10-13, wherein applying the one or more constraints includes: excluding content items having a same format as at least one content item of the first set of content items.

Example 15. The method of any one of examples 10-14, wherein applying the one or more constraints includes: excluding content items based on similarity scores that indicate a level of similarity to at least one content item of the first set of content items.

Example 16. The method of any one of examples 10-14, further comprising: determining, by the server, the similarity scores using a machine learning model.

Example 17. The method of any one of examples 10-16, wherein applying the one or more constraints includes: applying one or more parameters indicative of the format or content of the first set of content items as inputs to a machine learning model; and deriving at least one of the one or more constraints from an output of the machine learning model.

Example 18. The method of any one of examples 10-17, wherein the request is a remote procedure call (RPC).

Example 19. The method of any one of examples 10-18, further comprising: before selecting the plurality of content items, determining, by the server, that the first subset has a higher priority than the second subset, wherein performing the first one or more content selection procedures is in response to determining that the first subset has a higher priority than the second subset.

Example 20. The method of example 19, wherein: the first subset of the plurality of content slots includes at least a first content slot and a second content slot; the first one or more content selection procedures includes a third content selection procedure for the first content slot and a fourth content selection procedure for the second content slot; and performing the first one or more content selection procedures includes performing the third content selection procedure at least partially in parallel with performing the fourth content selection procedure.

Example 21. The method of any one of examples 10-20, wherein one or both of: the first subset of the plurality of content slots consists of a single content slot; and the second subset of the plurality of content slots consists of a single content slot.

Example 22. A server comprising one or more processors and one or more memories, the one or more memories storing instructions that, when executed by the one or more processors, cause the one or more processors to perform the method of any one of examples 1-21.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for efficiently selecting and providing client devices with content to fill content slots of information resources through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

1. A method for efficiently providing content to a client device, the method comprising:
receiving, by a server and from the client device, a request for content to be included in an information resource having a plurality of content slots;
in response to the request, selecting, by the server, one or more content items, including
determining first content selection results for a first subset of the plurality of content slots, at least by using selection parameters associated with candidate content items to perform a first one or more content selection procedures, and
based on the first content selection results, conditionally performing or not performing a second one or more content selection procedures for a second subset of the plurality of content slots; and
causing, by the server, the client device to fill one or more content slots, of the plurality of content slots, with the selected one or more content items.

2. The method of claim 1, wherein selecting the one or more content items includes:
not performing the second one or more content selection procedures when selecting a first set of one or more content items to fill the first subset of the plurality of content slots; and
performing the second one or more content selection procedures when not selecting any content any content items to fill the first subset of the plurality of content slots.

3. The method of claim 1, wherein:
determining the first content selection results includes selecting a first set of one or more content items to fill the first subset of the plurality of content slots; and
selecting the one or more content items includes conditionally performing or not performing the second one or more content selection procedures based on one or more characteristics of the first set of content items.

4. The method of claim 3, wherein the one or more characteristics of the first set of content items includes one or more relevancy scores associated with the first set of content items.

5. The method of claim 4, further comprising:
determining, by the server, the one or more relevancy scores using a machine learning model.

6. The method of claim 1, further comprising:
before selecting the one or more content items, determining, by the server, that the first subset has a higher priority than the second subset,
wherein performing the first one or more content selection procedures is in response to determining that the first subset has a higher priority than the second subset.

7. The method of claim 6, wherein:
the first subset of the plurality of content slots includes at least a first content slot and a second content slot;
the first one or more content selection procedures includes a third content selection procedure for the first content slot and a fourth content selection procedure for the second content slot; and
performing the first one or more content selection procedures includes performing the third content selection procedure at least partially in parallel with performing the fourth content selection procedure.

8. The method of claim 1, wherein one or both of:
the first subset of the plurality of content slots consists of a single content slot; and
the second subset of the plurality of content slots consists of a single content slot.

9. The method of claim 1, wherein the request is a remote procedure call (RPC).

10-21. (canceled)

22. A server comprising one or more processors and one or more memories, the one or more memories storing instructions that, when executed by the one or more processors, cause the one or more processors to:
receive, from a client device, a request for content to be included in an information resource having a plurality of content slots;
in response to the request, select one or more content items, wherein the selecting includes
determining first content selection results for a first subset of the plurality of content slots, at least by using selection parameters associated with candidate content items to perform a first one or more content selection procedures, and
based on the first content selection results, conditionally performing or not performing a second one or more content selection procedures for a second subset of the plurality of content slots; and
cause the client device to fill one or more content slots, of the plurality of content slots, with the selected one or more content items.

23. The server of claim 22, wherein selecting the one or more content items includes:
not performing the second one or more content selection procedures when selecting a first set of one or more content items to fill the first subset of the plurality of content slots; and
performing the second one or more content selection procedures when not selecting any content any content items to fill the first subset of the plurality of content slots.

24. The server of claim 22, wherein:
determining the first content selection results includes selecting a first set of one or more content items to fill the first subset of the plurality of content slots; and
selecting the one or more content items includes conditionally performing or not performing the second one or more content selection procedures based on one or more characteristics of the first set of content items.

25. The server of claim 24, wherein the one or more characteristics of the first set of content items includes one or more relevancy scores associated with the first set of content items.

26. The server of claim 25, wherein the instructions further cause the one or more processors to:
determine the one or more relevancy scores using a machine learning model.

27. The server of claim 22, wherein the instructions further cause the one or more processors to:
before selecting the one or more content items, determine that the first subset has a higher priority than the second subset,
wherein performing the first one or more content selection procedures is in response to determining that the first subset has a higher priority than the second subset.

28. The server of claim 27, wherein:
the first subset of the plurality of content slots includes at least a first content slot and a second content slot;
the first one or more content selection procedures includes a third content selection procedure for the first content slot and a fourth content selection procedure for the second content slot; and
performing the first one or more content selection procedures includes performing the third content selection procedure at least partially in parallel with performing the fourth content selection procedure.

29. The server of claim 22, wherein one or both of:
the first subset of the plurality of content slots consists of a single content slot; and
the second subset of the plurality of content slots consists of a single content slot.

30. The server of claim 22, wherein the request is a remote procedure call (RPC).
